(19) United States
(12) Patent Application Publication
(10) Pub. No.: US 2022/0266403 A1
(43) Pub. Date: Aug. 25, 2022

(54) WOOD AND METAL WORKING TOOLS HAVING A LOW FRICTION COATING

(71) Applicant: JPW Industries Inc., La Vergne, TN (US)

(72) Inventor: Jeffery Konkle, Murfreesboro, TN (US)

(21) Appl. No.: 17/677,878

(22) Filed: Feb. 22, 2022

Related U.S. Application Data
(60) Provisional application No. 63/151,133, filed on Feb. 19, 2021.

(51) Int. Cl. B23Q 1/03

(52) U.S. Cl. CPC B23Q 1/032

(57) ABSTRACT

A tooling system is disclosed for wood or metal working including a working element, and a work piece engagement surface at least partially surrounding, positioned adjacent to, or positioned proximate to, the working element, the work piece feedable toward the working element or the working element feedable across the work piece when the work piece is positioned against the work piece engagement surface; wherein the work piece engagement surface includes a low friction and/or non-stick coating.

### CROSS-REFERENCES TO RELATED APPLICATIONS

This application is a non-provisional of U.S. Patent Application No. 63/151,133 filed Feb. 19, 2021 entitled WOOD AND METAL WORKING TOOLS HAVING A LOW FRICTION COATING, which is hereby incorporated by reference in its entireties.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to industrial tooling systems such as wood-working and metal working tooling systems.

More particularly, the present disclosure relates to tooling systems where a work piece such as a piece of wood or metal are fed towards a working element such that the working element can perform a manufacturing operation on the work piece, or tool systems where a working element can be fed across a work piece. Such tooling systems can include, but are not limited to, table saws, band saws, sanders, grinders, jointers, planers, drill presses, scroll saws, shapers, routers, circular saws, jigsaws, reciprocating saws, belt sanders, etc. In such tooling systems, the work piece can be placed on a work table positioned around the working element (saw blades, cutting blades, sanding or grinding drums, drill bits, etc.) and the work piece can be fed toward and/or past the working element such that the manufacturing operation such as a cutting, sanding, grinding, or other desirable manufacturing operation, can be performed on the work piece.

In such embodiments, the user or mechanism on the tooling system is required to push or feed the work piece toward the working element. In conventional tooling systems, the work table can be a wooden, metal, stone, or composite plastic work table. Work pieces can be prone to sliding resistance or sticking on the work table, or can be difficult to push on the work table, due to inherent friction on the work table or corrosion occurring on the work table surface, which can cause inefficiencies or disruptions in the manufacturing procedure, as well as fatigue on the user. Additionally, a user may provide increased pressure or force on the work piece to overcome the sticking of the work piece on the work table. If the work piece subsequently slips, the increased force applied to the work piece by the user can create a safety hazard as the user's hands or other extremities may unintentionally hit the working element, causing injury to the user.

What is needed then are improvements to industrial tooling systems.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a tooling system including a working element, and a work piece engagement surface at least partially surrounding, positioned adjacent to, or positioned proximate to, the working element, the work piece feedable toward the working element or the working element feedable across the work piece when the work piece is positioned against the work piece engagement surface; wherein the work piece engagement surface includes a low friction and/or non-stick coating.

One aspect of the disclosure is a tooling system for performing a manufacturing operation on a work piece, the tooling system including a working element. A work table can at least partially surround the working element, the work table having a work piece engagement surface. The work piece can be fed toward or past the working element when the work piece is positioned on the work piece engagement surface of the work table. The work piece engagement surface of the work table can include a low friction coating. In some embodiments, the low friction coating can be a fluoropolymer coating, including, but not limited to, a polytetrafluoroethylene coating.

The low friction coating can provide the benefit of helping reduce the force needed to pass the work piece through or engage the work piece with the working element of the tooling system, which can help reduce user fatigue and also help reduce the possibility of a slipping accident and injury as less force is needed to perform the manufacturing operation. Less force on the work piece can also produce less force on the working element itself which can help reduce power consumption for the tooling system.

In some embodiments, the low friction coating can be a multilayer coating. For instance, the low friction coating in some embodiments can include a primer coat, a middle coat including a polytetrafluoroethylene, and a top coat comprising perfluoroalkoxy, ceramic, or other materials. The low friction layer can have an increased overall thickness in some embodiments to help extend the life of the low friction coating in highly corrosive or abrasive environments. For instance, regularly feeding of heavy wooden or metallic work pieces across the low friction coating can subject the low friction coating to highly abrasive forces. In some embodiments, the combined or overall thickness of the low friction coating can be at least 30 micrometers to help extend the useful life of the low friction coating in the highly abrasive environments associated with industrial tooling systems.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of a tooling system such as a table saw of the present disclosure including a work table with a low friction coating.

FIG. 2 is a top view of the work table of FIG. 1 showing a work piece being fed on the work table toward a work element of the table saw.

FIG. 3 is a side view of the table saw work table of FIG. 1.

FIG. 4 is a side view of another embodiment of a work table of the present disclosure having a low friction coating with multiple layers.

FIG. 5 is a perspective view of a work table of the present disclosure with a low friction polytetrafluoroethylene coating.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

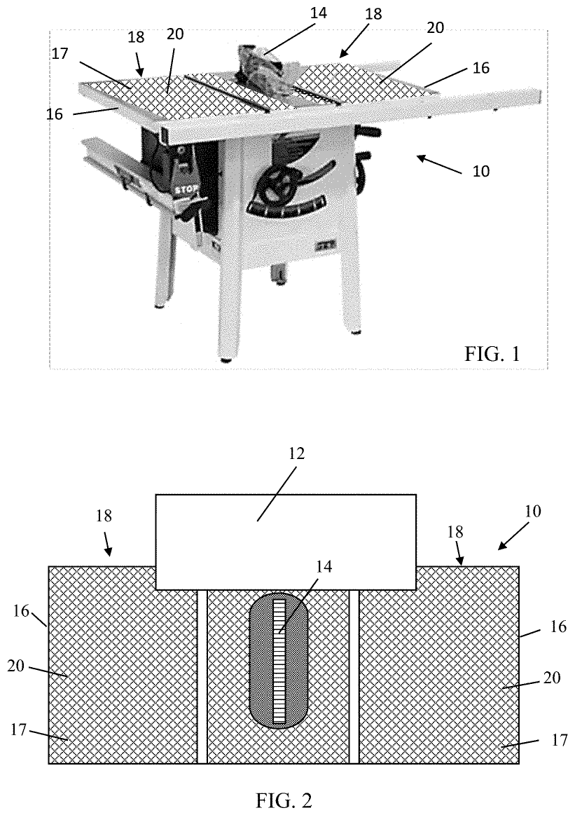

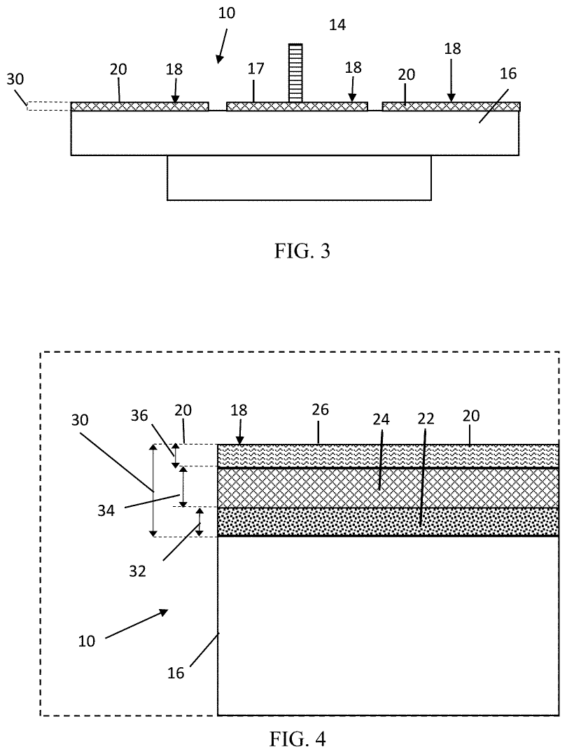

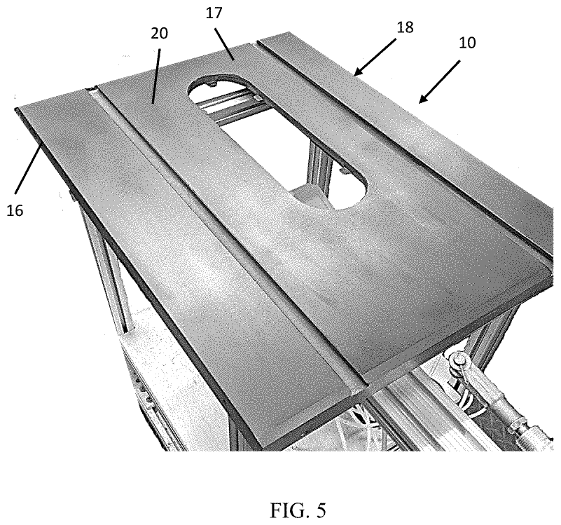

As shown in FIGS. 1-3, one aspect of the present disclosure is a tooling system 10 for performing a manufacturing operation on a work piece 12 including a working element 14. A work piece engagement surface 18 can at least partially surrounding the working element 14, the work piece 12 feedable toward the working element 14 or the working element 14 feedable across the work piece 12 when the work piece 12 is positioned against the work piece engagement surface 18. The work piece engagement surface 18 can include a low friction or non-stick coating 20.

Another aspect of the present disclosure is a tooling system 10 for performing a manufacturing operation on a work piece 12, the tooling system 10 including a working element 14. A work table 16 can at least partially surround the working element 14, the work table 16 having a work piece engagement surface 18. The work piece engagement surface 18 can be an upper surface 17 (table saws) applications, a side-facing surface, or a combination of an upper and a side-facing surface (planers). The work piece 12 can be feedable toward the working element 14 when the work piece 12 is positioned on the work piece engagement surface 18 of the work table 16.

In some embodiments, the tooling system 10 can be any one of various types of tooling systems wherein a work piece 12 is fed towards a working element 14 on the tooling system 10. For instance, the tooling system 10 can include, but is not limited to, table saws, band saws, sanders, grinders, jointers, planers, scroll saws, shapers, routers, etc. wherein the work piece 12 can be advanced on the work piece engagement surface toward the working element 14. The working element 14 of the tooling system 10 can be any suitable working element 14 for the intended manufacturing operation, including but not limited to saw blades, cutting blades, sanding or grinding drums, drill bits, etc. In some embodiments, the tooling system 10 can be a hand held tooling such as circular saws, reciprocating saws, jig saws, belt sanders, grinders, etc., that can have a work piece engagement surface 18 on a plate or other portion of the tooling system 10 that can be pressed against the work piece 12 and passed or slid across the work piece 12 to make the desired cut or other manufacturing operation.

The work piece engagement surface 18 of the work table 16 can include a low friction coating 20. The low friction coating 20 can also be described as a non-stick or high lubricity coating 20. In some embodiments, the low friction coating 20 can be a fluoropolymer coating, including, but not limited to, a polytetrafluoroethylene (PTFE) coating, such as the PTFE coating sold under the tradename Teflon® by DuPont de Nemours, Inc. In some embodiments, the low friction coating 20 can have a coefficient of kinetic friction that is less than 0.2. In comparison to cast iron for instance that has a coefficient of kinetic friction of roughly 0.5, the low friction coating 20 can substantially reduce the friction forces on work pieces 12 being passed over the work table 16. In some embodiments, the low friction coating 20 can have a coefficient of kinetic friction that is less than 0.15, 0.14, 0.13, 0.12, 0.11, 0.1, 0.09, 0.08, 0.07, or 0.06. In still other embodiments, the low friction coating 20 can have a coefficient of kinetic friction that is less than 0.05. For instance, Teflon® coatings can have a coefficient of kinetic friction between about 0.02 and 0.05 with respect to objects of different material composition. In some embodiments, the low friction coating 20 can have a coefficient of kinetic friction of between 0.01 and 0.2, 0.02 and 0.2, 0.03 and 0.2, 0.04 and 0.2, 0.05 and 0.2, 0.1 and 0.2, 0.01 and 0.1, 0.02 and 0.1, 0.03 and 0.1, 0.04 and 0.1, 0.05 and 0.1, 0.01 and 0.15, 0.02 and 0.15, 0.03 and 0.15, 0.04 and 0.15, 0.05 and 0.15, 0.1 and 0.2, or 0.15 and 0.2.

In some embodiments, the low friction coating 20 can be a multilayer coating. For instance, in some embodiments, the low friction coating 20 can include a middle coat 24 and a top coat 26, the middle coat 24 being positioned between the top coat 26 and the work table 16. In some embodiments, the low friction coasting 20 can include a primer coat 22 positioned beneath the middle coat 24 or between the middle coat 24 and the work table. In some embodiments, the primer coat 22, the middle coat 24, and the top coat 26 can include different fluoropolymers, including but not limited to suitable PTFEs and/or suitable perfluoroalkoxy (PFA) compounds. In some embodiments, the top coat 26 can include one or more ceramic materials. The primer coat 22 can be any suitable primer material for helping the low friction or fluoropolymer middle coat 24 and top coat 26 adhere to the work table 16. In one embodiment, the middle coat 24 can include a suitable PTFE coating and the top coat 26 can include a suitable PFA coating. The combination of different fluoropolymer layers 24, 26 can help provide varying protections associated with the various fluoropolymers used. For instance, PTFE coatings can help provide increased abrasion and heat resistance properties to the work table 16.

In some embodiments, the low friction coating 20, such as PTFE, can also provide corrosion resistance to the work piece engagement surface 18 which can help prevent corrosion on the work piece engagement surfaces 18. Corrosion can occur for instance when humidity or moisture, or other environmental catalysts, react with the work table 16, particularly iron tables which are prone to corrosion and rusting. Corrosion on work tables 16 can substantially increase friction between the work table and the work pieces 12, and particularly with respect to wooden work pieces being passed over the work table 16. Having a low friction coating 20 with anti-corrosive properties can thus provide both low friction engagement with the work piece 12 and help maintain such low friction properties by reducing corrosion occurring on the work table 16. PFA coatings can help provide similar low friction and anti-corrosive properties and also increased chemical resistance properties to the work table 16.

In some embodiments, the low friction coating 20 can include a single layer including a mixture of one or more of a primer coat material, PTFE and PFA, such that a single layer of low friction coating material can be applied to the work table 16 that includes both PTFE and PFA, and a primer agent that allows for better adherence of the low friction coating to underlying metal or wooden work tables 16.

In many conventional applications of low friction fluoropolymers, the fluoropolymer layers are applied at thicknesses or dry film thicknesses of between 10 and 30 micrometers. Small scratches in low friction layers can thus significantly reduce the low friction properties in conventional coating layers. In some embodiments of the present disclosure, the low friction coating 20 can have an increased overall thickness to help extend the life of the low friction coating 20 in highly corrosive or abrasive environments. For instance, regularly feeding of heavy wooden or metallic items across the low friction coating 20, often with hard or jagged edges pre or post manufacturing operation, can subject the low friction coating 20 to highly abrasive forces. In some embodiments, the combined or overall thickness 30 of the low friction coating 20 can be at least 25 micrometers. In some embodiments, the combined or overall thickness 30 of the low friction coating 20 can be at least 30 micrometers, to help extend the useful life of the low friction coating 20 in the highly abrasive environments associated with industrial tooling systems. In some embodiments, the combined or overall thickness 30, of the low friction coating 20 can be at least 40 micrometers. In some embodiments, the combined or overall thickness 30 of the low friction coating 20 can be at least 50 micrometers. The overall thickness 30 can include the cumulative thicknesses 32, 34, 36 of the primer coat 22, the middle coat 24, and the top coat 26 respectively. In some embodiments, the combined thicknesses 34 and 36 of the middle coat 24 and the top coat 26, respectively, can be at least 30 micrometers. In one embodiment, with a single 32 micrometer fluoropolymer coating on a table saw work table, the work table was able to withstand 20,000 passes of wood work pieces over the work table without any significant damage to the work table low friction coating. In other embodiments, with a single 32 micrometer fluoropolymer coating on a table saw work table, the work table was able to withstand up to 50,000; 100,000; 150,000; 200,000; or 250,000 passes of wood work pieces over the work table without any significant damage to the work table non-stick coating, or maintaining a coefficient of kinetic friction of less than 0.2.

Thus, although there have been described particular embodiments of the present invention of a new and useful WOOD AND METAL WORKING TOOLS HAVING A LOW FRICTION COATING, it is not intended that such references be construed as limitations upon the scope of this invention.

What is claimed is:

1. A tooling system for performing a manufacturing operation on a work piece, the tooling system comprising:
a working element; and
a work piece engagement surface at least partially surrounding the working element, the work piece feedable toward the working element or the working element feedable across the work piece when the work piece is positioned against the work piece engagement surface;
wherein the work piece engagement surface includes a low friction coating.

2. The tooling system of claim 1, wherein the low friction coating is a fluoropolymer coating.

3. The tooling system of claim 2, wherein the low friction coating is a polytetrafluoroethylene coating.

4. The tooling system of claim 1, wherein the low friction coating has a thickness of at least 30 micrometers.

5. The tooling system of claim 1, wherein the low friction coating is a multilayer coating.

6. The tooling system of claim 5, wherein the low friction coating further comprises:
a middle coat comprising polytetrafluoroethylene; and
a top coat comprising a ceramic material.

7. The tooling system of claim 6, wherein the combined thickness of the middle coat and the top coat is at least 30 micrometers.

8. The tooling system of claim 6, further comprising a primer coat beneath the middle coat.

9. The tooling system of the claim 1, further comprising:
a work table having an upper surface, the working element extending from the work table;
wherein the work piece engagement surface is the upper surface of the work table.

10. The tooling system of claim 9, wherein the working element extends upward through the work table and the low friction coating surrounds the working element in all directions.

11. The tooling system of claim 1, wherein the low friction coating has a coefficient of kinetic friction of less than 0.2.

12. The tooling system of claim 10, wherein the low friction coating has a coefficient of kinetic friction of less than 0.1.

13. The tooling system of claim 11, wherein the low friction coating has a coefficient of kinetic friction of between 0.02 and 0.1.

14. The tooling system of claim 1, wherein the low friction coating is made from a corrosion resistant material.

15. The tooling system of claim 1, wherein the low friction coating can withstand at least 20,000 passes of the workpiece over the low friction coating while maintaining a coefficient of kinetic friction of less than 0.2.

16. A tooling system for performing a manufacturing operation on a work piece, the tooling system comprising:
a working element; and
a work piece engagement surface at least partially surrounding the working element, the work piece feedable toward the working element or the working element feedable across the work piece when the work piece is positioned against the work piece engagement surface;
wherein the work piece engagement surface includes a multilayered low friction coating having a thickness of at least 25 micrometers and a coefficient of kinetic friction of less than 0.1.

17. The tooling system of claim 16, wherein the low friction coating is a combination includes both polytetrafluoroethylene and perfluoroalkoxy.

18. A tooling system for performing a manufacturing operation on a work piece, the tooling system comprising:
a working element; and
a work piece engagement surface at least partially surrounding the working element, the work piece feedable toward the working element or the working element feedable across the work piece when the work piece is positioned against the work piece engagement surface;
wherein the work piece engagement surface includes a multilayered low friction coating having a middle coat comprising polytetrafluoroethylene and a top coat comprising ceramic, the low friction coating having a thickness of at least 25 micrometers and a coefficient of kinetic friction of less than 0.2.

19. The tooling system of claim 18, wherein the low friction coating can withstand at least 20,000 passes of the workpiece over the low friction coating while maintaining a coefficient of kinetic friction of less than 0.2, and the low friction coating is made from a corrosion resistant material.

20. The tooling system of claim 18, further comprising a primer coat beneath the middle coat, wherein the combined thickness of the middle coat and the top coat is at least 25 micrometers.
